(19) United States
(12) Patent Application Publication
(10) Pub. No.: US 2008/0174922 A1
(43) Pub. Date: Jul. 24, 2008

(54) Method and apparatus for detecting ground fault current on a power line

(75) Inventor: Mahlon D. Kimbrough, Sherman, TX (US)

Correspondence Address: HAMILTON, BROOK, SMITH & REYNOLDS, P.C., 530 VIRGINIA ROAD, P.O. BOX 9133, CONCORD, MA, 01742-9133, US

(73) Assignee: Tellabs Bedford, Inc.

(21) Appl. No.: 11/655,349

(22) Filed: Jan. 19, 2007

(51) Int. Cl. H02H 3/08

(52) U.S. Cl. 361/42

(57) ABSTRACT

A ground fault interrupt (GFI) circuit detects and interrupts a ground fault, even in the presence of AC power induced currents. The GFI circuit can be used for power delivery between nodes in a network, such as from a central office to remote network equipment. The GFI circuit meets GFI specifications covering such an application. The GFI circuit detects rapid changes and slow rises in ground fault current. Safety features, such as intermittent interruptions of power on power lines in an event of a ground fault, are supported by the GFI circuit to protect field personnel. A digital processor may be used to implement aspects of the GFI circuit to support changes of or various operating environments.

### BACKGROUND OF THE INVENTION

As the number and variety of services provided by telecommunications service providers has grown, so too has the demand for power necessary to operate the associated equipment. To provide additional power, equipment providers have increased the source voltage of the power supplies used to power the remote units. These increases have resulted in potentially dangerous operating conditions for service persons that install and maintain the equipment.

Within a telecommunications system, network power is commonly generated in a centralized location and distributed to a number of remote locations, particularly with equipment close to end subscribers. For example, a remote device terminal may contain an optical interface unit that provides power over a transmission link, such as a twisted pair of wires, to a number of remotely located optical network units. In addition to being more economical, it may be more practical than generating power at each remote unit. However, the twisted pair of wires often use the same transmission delivery infrastructure (e.g., telephone poles) that is used to deliver alternating current (AC) power to end subscribers. High power levels in AC power lines and resulting electromagnetic induction may induce an AC power line current on network power lines (e.g., the twisted pair of wires).

To protect service persons, a number of safety standards have been created. These industry standards define operating conditions and requirements for telecommunication equipment. To obtain certification by a particular standards board, equipment must adhere to the standards required by that particular standards committee. Underwriters Laboratories Inc. (UL) has published the “Standard for Safety for Information Technology Equipment—Safety—Part 21: Remote Power Feeding, UL 60950-21,” the entire teachings of which are incorporated herein by reference, which defines various safety standards. For example, section 6.2.3 of that standard states that a voltage limited remote feeding telecommunications (RFT-V) circuit whose open circuit voltage exceeds 140 volts (V) direct current (DC) shall limit the ground fault current to 10 milliamps. Another standard, Telcordia GR-1089 Issue 3, Table 5-2, the entire teachings of which are incorporated herein by reference, further requires that the 10 milliamps be detected in the presence of 7.1 milliamps root mean square (RMS) of AC power line induced current on a two-pair circuit.

To protect service personnel, equipment should be able to detect ground fault current conditions that result when a person is accidentally exposed to a hazardous operating condition and shut down the power source should the ground fault current condition continue. Ground fault currents may occur rapidly or they may occur more slowly. Thus, there is a need to be able to detect both rapidly and slowly occurring ground fault currents in the presence of AC power line induced currents.

### SUMMARY OF THE INVENTION

A system in accordance with an embodiment of the present invention includes a switch to interrupt current on a power line when a ground fault is detected. The system may further include a fast response unit and a slow response unit. The fast response unit may produce a state change of a fast response output based on the current on a power line to indicate a ground fault at a first time after the ground fault occurs. The slow response unit may produce a state change of a slow response output based on the current on the power line to indicate a ground fault at a second time after the ground fault occurs. The second time may be later than the first time. The system also includes a switch that may be responsive to the state change of the fast and slow response outputs and may interrupt the current on the power line in an event the state change of the fast or slow response output indicates a ground fault.

The fast response unit and the slow response unit may detect ground fault currents in the presence of large loop DC currents and common mode AC induced currents. Thus the system may detect both rapidly and slowly occurring ground fault currents in the presence of AC power line induced current.

### BRIEF DESCRIPTION OF THE DRAWINGS

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

FIG. 1 is a block diagram of a communications network including a system in which an embodiment of a ground fault interrupt (GFI) unit of the present invention may be deployed;

FIGS. 2A and 2B are detailed block diagrams of an optical interface unit of FIG. 1 with a ground fault interrupt unit in accordance with embodiments of the present invention;

FIG. 3 is a functional block diagram of a circuit in the ground fault interrupt unit of FIG. 1 in accordance with one embodiment of the present invention;

FIG. 4 is a more detailed diagram of the ground fault interrupt circuit of FIG. 3 in accordance with one embodiment of the present invention;

FIG. 5 is a functional diagram of the switch in connection with the ground fault interrupt circuit of FIGS. 3 and 4 in accordance with one embodiment of the present invention;

FIG. 6 is a schematic diagram of the sensor of FIG. 4 in accordance with one embodiment of the present invention;

FIG. 7A is a symmetrical impulse response plot of a fast response unit in accordance with one embodiment of the present invention;

FIG. 7B is a step response plot of a fast response unit in accordance with one embodiment of the present invention;

FIG. 7C is a gain response plot of a fast response unit in accordance with one embodiment of the present invention;

FIG. 8A is a plot of a ground fault current that may be detected in accordance with one embodiment of the present invention;

FIG. 8B is an output response plot of a fast response unit and a slow response unit in accordance with embodiments of the present invention;

FIG. 9 is a flow diagram illustrating a method for interrupting the current on a power line due to a ground fault interrupt in accordance with one embodiment of the present invention; and

FIG. 10 is a flow diagram illustrating a method for interrupting the current on a power line due to a ground fault interrupt and attempting to restore power in accordance with one embodiment of the present invention.

### DETAILED DESCRIPTION OF THE INVENTION

A description of example embodiments of the invention follows.

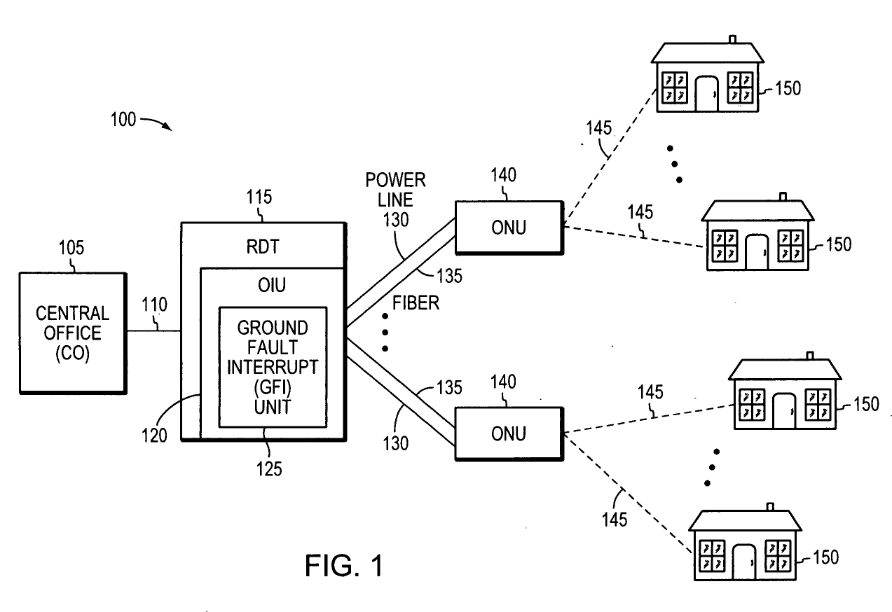

FIG. 1 is a network diagram of an exemplary portion of a telecommunications network 100 in which an embodiment of the present invention may be deployed. A Central Office (CO) 105 communicates with a Remote Device Terminal (RDT) 115 via communications link 110. Within the RDT 115 is an Optical Interface Unit (OIU) 120. Within the OIU 120 is a Ground Fault Interrupt (GFI) unit 125. The OIU 120 in turn, communicates with Optical Network Units (ONU) 140 via fiber connections 135 and power lines 130 (e.g., twisted pair wires). The ONUs 140, in turn, communicate via copper links 145 (e.g., twisted pair wires) with devices (not shown) in end user premises 150 (e.g., homes or workplaces).

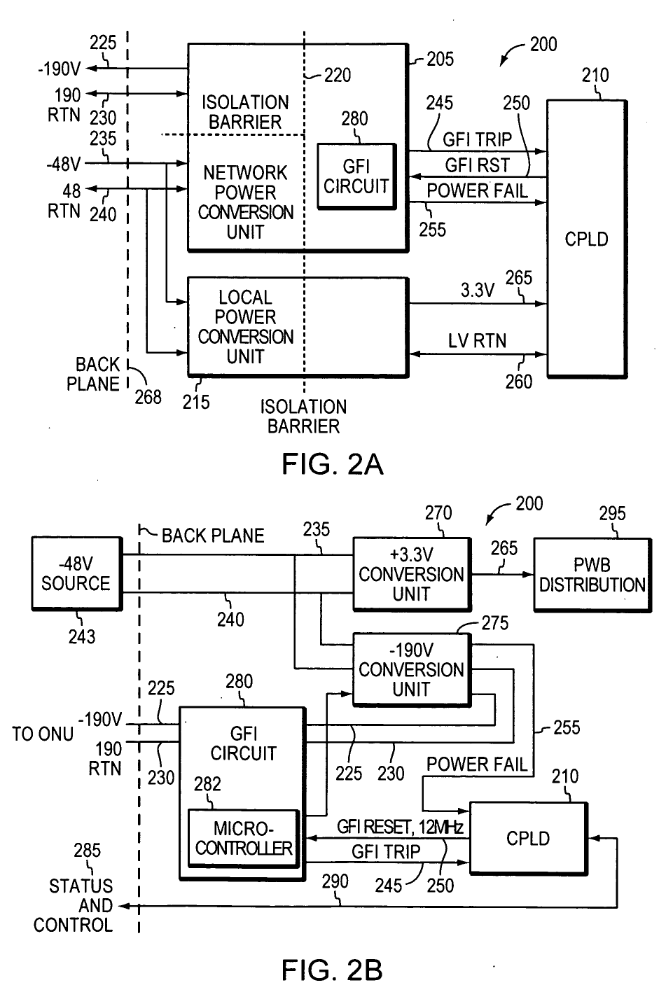

With the recent development of and increased demand for telecommunications services, such as Internet Protocol television (IPTV), higher bandwidth signals between the OIU 120 and ONUs 140 have caused an increase in power usage by the ONUs 140. To support an increased power draw, the OIU 120, which supplies power for the ONUs 140 rather than a remote power source such as a power line, drives −190V DC rather than, for example, the −140V DC of earlier systems. The voltage increase results in safety and ground fault interrupt (GFI) issues, such as AC power line induced signals, that are not issues at the lower voltage. Embodiments of the present invention address the difficulty of detecting ground fault currents in the presence of AC induced signals. Moreover, embodiments of the present invention address fast and slow rising ground fault currents and support safety issues by providing, for example, a mechanism to allow a service person to release the power line 130 should the person's handling of the power line be the source of the ground fault. Other features are described in reference to FIGS. 2A-10.

FIGS. 2A and 2B are block diagrams of an exemplary portion of a power supply section 200 of an OIU, such as the OIU 120 of FIG. 1, in accordance with embodiments of the present invention. Referring to FIG. 2A, two power conversion units are provided: a network power conversion unit 205 and a local power conversion unit 215. Both power conversion units 205, 215 are connected to a −48V power supply via a −48 V supply line 235 and a 48 V return (RTN) line 240. The network power conversion unit 205 also communicates with a complex programmable logic device (CPLD) 210 via a variety of control and status signals, such as GFI trip 245, GFI reset (RST) 250, and power fail 255.

The local power conversion unit 215 may be a low voltage power supply, for example, providing +3.3 volts via a 3.3V line 265 and a low voltage return (LV RTN) line 260. The network power conversion unit 205 may also generate a high voltage signal, for example, −190V via a −190V line 225 and 190 RTN line 230 for transmission along a backplane 268. In the example embodiment, the CPLD 210 is isolated from sections of the network power conversion unit 205 and local power conversion unit 215 via an isolation barrier 220. The −190V signals 225 and 230 and associated circuitry (not shown) may also be isolated from the −48 volts signals 235 and 240 via the isolation barrier 220.

FIG. 2B depicts, in further detail, the network power supply section 200 of the OIU 125 of FIG. 1. A local power conversion unit 270, i.e., +3.3V conversion unit 270, and a network power conversion unit 275, i.e., −190V conversion unit 275, are connected to the −48V source 243 via lines 235 and 240. The output of the +3.3V conversion unit 270 is connected to the PWB distribution unit 295 via a connection 265. In this embodiment, the local power conversion unit 270 is a low power DC supply that typically provides two voltages: +3.3V for the OIU optics and logic sections (not shown), and +12V bias voltage for the network power conversion unit 275.

Since the local power conversion unit 270 is a low power supply (typically less than 5 watts), a flyback converter (not shown) may be used to minimize parts count. A converter switch (not shown) may drive the primary of a coupled inductor (not shown) with three secondary windings that provide the source for three voltage rails. Voltage rails track closely in a flyback converter, so the voltage feedback is simplified by regulating a +12V DC bias voltage that is referenced to the −48V input voltage. Current mode control may be used to improve stability and inherent voltage feed-forward. To minimize power loss, a high voltage startup regulator allows the control circuit to begin operation on the −48V source 243, but switched to the +12V DC bias source (not shown) once the flyback converter is operating.

Because a precision +3.3 V DC (e.g., ±5%) is required to power the logic and optics sections, a post regulator (not shown) may be used on the 4V DC output of the flyback converter. The post regulator circuit provides an accurate +3.3 V DC with minimal effect on the overall circuit efficiency. The +3.3 V DC and +12 V DC voltage outputs of the local power conversion unit 270 are fed to the PWB distribution unit 295 via connection 265.

The network power conversion unit 275 may be a high power, high voltage DC power supply with outputs 225, 230 that are current limited and ground fault-protected by a GFI circuit 280. The network power conversion unit 275 may be a DC isolated forward DC to DC using a forward converter topology. The secondary winding (not shown) may have a center tap winding (not shown) to allow two 95V outputs to be summed to 190V. A common core coupled inductor (not shown) may be used on the outputs 225, 230. A split secondary approach causes lower voltage stresses on all high voltage components and minimizes losses on secondary rectifiers as well as lower cost, lower voltage filter capacitors. The network power conversion unit 275 may provide 100 watts: 50 watts for the ONU 140 and 50 watts that may be “dropped” across the power lines 130 that provide power to the ONU 140 of FIG. 1.

At a power level of 100 watts, the added complexity of the forward topology over that of a flyback design may be warranted because forward converters are inherently more stable. Forward converters are isolated BUCK converters and, therefore, supply power on both ON and OFF cycles of the primary switch. Flyback converters transfer power to the output only when the primary switch is turned OFF. The output of a flyback should be sustained by the output capacitor (not shown) while the primary switch is ON. This is useful because the ONU may have the added requirement of a ground fault interrupter (GFI), which means that a load may swing from 100 watts (full load) to 0 watts (no load) and back quickly again. The design may be implemented as a single switch, active clamp/reset, forward converter with current mode control. An active clamp/reset circuit maximizes power density and efficiency. The voltage feedback may be provided over a high bandwidth opto-coupler circuit, which may be driven by a precision voltage feedback operational amplifier and secondary side current limit circuit.

A GFI circuit 280 is provided to protect craftsmen from electrical shock. The GFI circuit has an added benefit of extinguishing protection components, such as gas tubes that create fault currents to ground. The GFI circuit 280 may use a microcontroller 282 to monitor large loop DC current and common mode ground fault current of the network power line and interrupt power if a ground fault current is detected. A ground fault current event may be indicated by a GFI trip signal via a connection 245 between the GFI circuit 280 and CPLD 210. Status and control signals 285 may be communicated to and from the CPLD 210 via another connection 290. The network power conversion unit 275 may also communicate a power fail signal 255 to the CPLD 210.

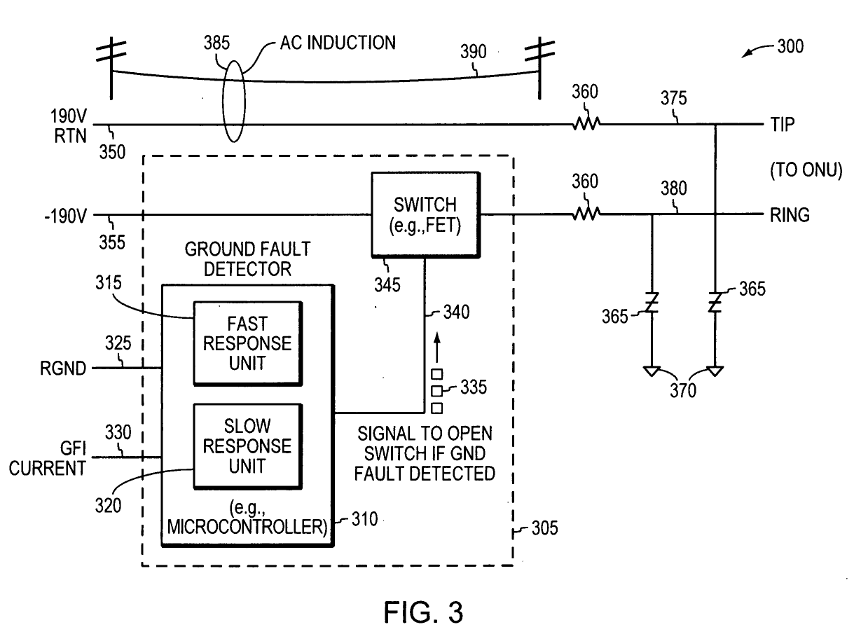

FIG. 3 is a block diagram of an example GFI circuit, such as the GFI circuit 280 of FIG. 2B. Power lines between an OIU and an ONU (see FIG. 1) may be provided as twisted pair wires, sometimes referred to as a tip lead 375 and a ring lead 380. One side of the tip lead 375 may be connected to a resistor 360, and the other side of the resistor 360 may be connected via a connection 375 to the ONU (not shown) and an over-voltage protection device, such as a sidactor 365 for lightening strike protection. In the example embodiment of FIG. 3, a switch 345 is placed in-line with the −190V lead 355. The switch 345 is responsive to a signal 335, which may be analog or digital depending on implementation, to open and close the switch 345. The switch may be implemented in a variety of ways known to one skilled in the art, for example, a MOSFET. In this example embodiment, the output side of the switch 345 may also be connected to a resistor 360, and the other side of the resistor 360 is connected to the ONU and the protection device 365, which may be connected to ground 370.

The ground fault interrupter 305 contains a fast response unit 315 and a slow response unit 320 that may be part of, for example, a microcontroller 310 or other electrical/electronic device(s) suitable and configured to support GFI in a manner disclosed herein. The ground fault interrupter 305 may detect a ground fault condition based on input signals RGND 325 and GFI Current 330 (discussed below in reference to FIG. 6 in more detail). Upon detection of a ground fault condition, the ground fault detector 310 may communicate a signal 335 via connection 340 to open the switch 345. As described in further detail below, the ground fault detector 310 may open the switch 345 temporarily, intermittently, or until the ground fault detector 310 is manually reset.

Power lines tip 375 and ring 380 are often run in parallel with AC power lines 390 as they make their way from the RDT 115 to the ONU 140. Referring to FIG. 3, AC power lines 390 may create an AC induction field 385 that results in a current being induced on the tip 375 and ring 380 leads. Typically, induced current appears as a periodic common mode current that may produce a false indication of a ground fault condition. An exemplary embodiment of the present invention described herein provides a system and corresponding method that detects ground fault currents in the presence of the induced currents produced by the AC power line induction 385 and reduces false ground fault events.

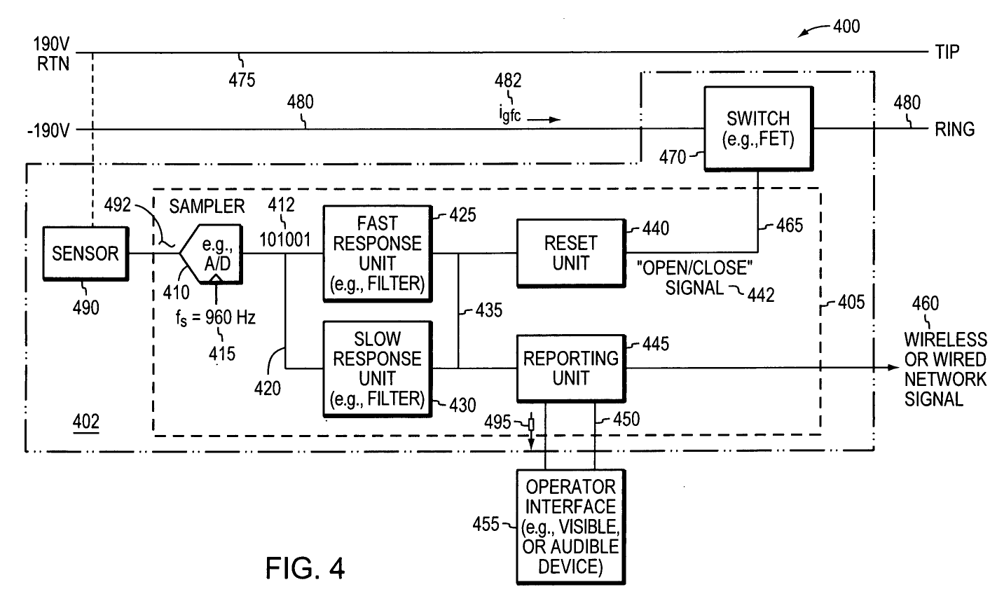

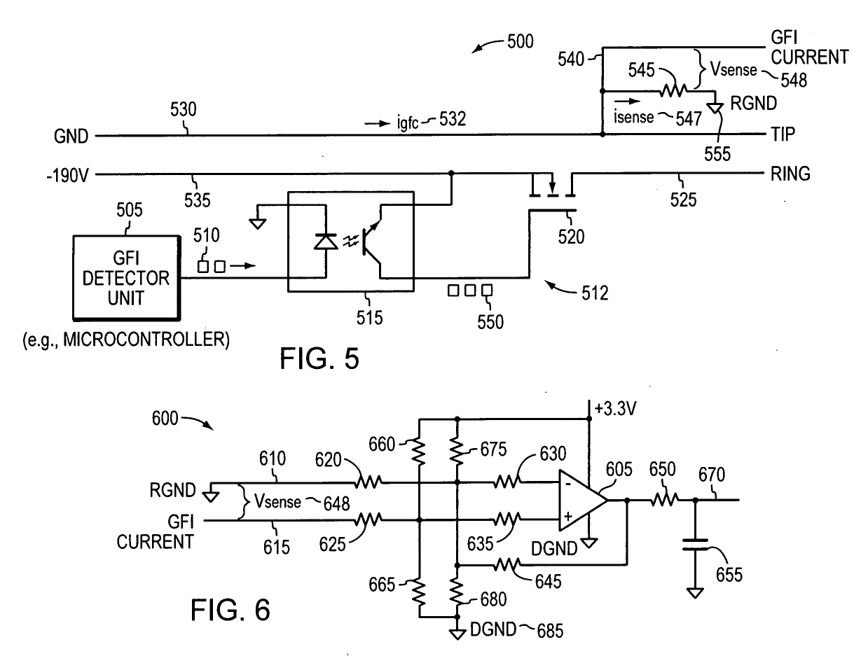

FIG. 4 is a detailed block diagram of an example ground fault interrupter 402, such as the ground fault interrupter 305 shown in FIG. 3. In the example ground fault interrupter 402, a sensor 490 coupled to sense resistors (discussed below in reference to FIGS. 5 and 6) and is configured to produce an analog signal 492 representative of ground fault currents i_{gfc} 482 in a telecommunications network power system 400. The analog signals 492 are communicated to a ground fault detection unit 405. The analog signals 492 may then be digitized into a digital signal 412 using a sampler 410 sampling the output of the sensor 490 at a particular sampling rate 415 using sampling methods known to those skilled in the art. Alternatively, other analog signal processing methods employing, for example, discrete components may also be used.

The digital signals 412 are then communicated to a fast response unit 425 and a slow response unit 430 via a connection path 420. Examples of a fast response unit 425 and slow response unit 430 may include, for example, software filters, such as a finite impulse response (FIR) filter, among others. Outputs of the fast response unit 425 and slow response unit 430 may be communicated to a reset unit 440 and a reporting unit 445 via a connection path 435. The reset unit 440 may then communicate an ‘open/close’ signal 442 to open or close a switch 470 via a connection path 465, causing power on a downstream portion of the ring lead 485 relative to the switch 470 to be interrupted or restored, respectively.

A reporting unit 445 coupled to the fast and slow response units 425, 430 via a connection path 435 may provide a status indicator signal 495 indicative of a ground fault condition to an operator interface 455. Indicators may, for example, be visual, such as a light produced by a light emitting diode (LED) (not shown) or an indicator on a display screen at the operator interface 455, or an audible alert, such as a beeping sound, to notify an operator that a ground fault condition has occurred. The status indicator signal may also be a wireless signal or a wired signal 460 that may, for example, be transmitted on a network (not shown) using methods known in the art to a person's pager or personal communications device, such as a cell phone or to a central monitoring facility.

FIG. 5 depicts a circuit diagram of an exemplary embodiment of a switch 512, such as the switch 470 shown in FIG. 4. A tip lead 530 of the network power supply 500 is referenced to RGND 555 through a sense resistor 545. A ring lead 525, 535 is nominally at −190V DC with respect to ground. A ground fault current i_{gfc} 532 from the tip lead 530 to earth ground (i.e., RGND 555) results in a current through the sense resistor 545 that is communicated in the form of a corresponding voltage Vsense 548 via a connection 540 and RGND 555 to a sensor described below and in FIG. 6 in more detail.

Continuing to refer to FIG. 5, when a ground fault interrupt detection unit 505 detects a ground fault event, it may generate a signal 510 and send the signal 510 to an opto-coupler 515. The opto-coupler 515, in turn, generates a signal 550 (e.g., closes an internal pathway) that is communicated to a switch, for example, the gate of an n-channel MOSFET 520, to open or close the MOSFET 520. The n-channel MOSFET 520, in turn, interrupts the current or restores the current on the ring 535 lead. Other circuit design techniques known in the art may be used to limit current flow in a network power line.

FIG. 6 is a schematic diagram of a sensor 600, such as the sensor 490 shown in FIG. 4, to sense ground current. An input signal, GFI Current 615, shown in FIG. 5 as signal 540, represents a sense current through the sense resistor 545. Note that GFI current 615 may be provided in the form of a voltage Vsense 648. The GFI Current signal 615 is connected to one side of a resistor 625. The other side of the resistor 625 is connected to level shifting resistors 660 and 665 for bias purposes and to a positive input resistor 635.

A reference sense resistor 620 may have one side tied to RGND via a connection 610 and the other side connected to level shifting resistors 675 and 680, also for bias purposes, a negative input resistor 630, and a feedback resistor 645. The other side of the input resistor 635 is connected to the positive input of a differential amplifier 605, and the other side of input resistor 630 is connected to the negative input of the differential amplifier 605.

The output of the differential amplifier 605 is connected to the feedback resistor 645 and output resistor 650. The other side of level shift resistors 660 and 675 and a supply lead of the differential amplifier 605 are connected to a power supply, such as the +3.3V source generated in the local power conversion shown in FIG. 2B. The other side of level shift resistors 665 and 680 and another supply lead of the differential amplifier 605 may be connected to DGND 685. An output capacitor 655 may be connected to the other side of output resistor 650 to create a low-pass filter to improve signal quality for use by subsequent components (not shown) in the signal chain.

The differential voltage across the sense resistors may be amplified and offset so that ±27.5 milliamps of current corresponds to an input range (e.g., +511 to −512) of a sampler, such as the sampler 410 shown in FIG. 4. The sense resistor 545 also senses AC inducted currents. Other circuit designs may be envisioned that produce similar results known in the art.

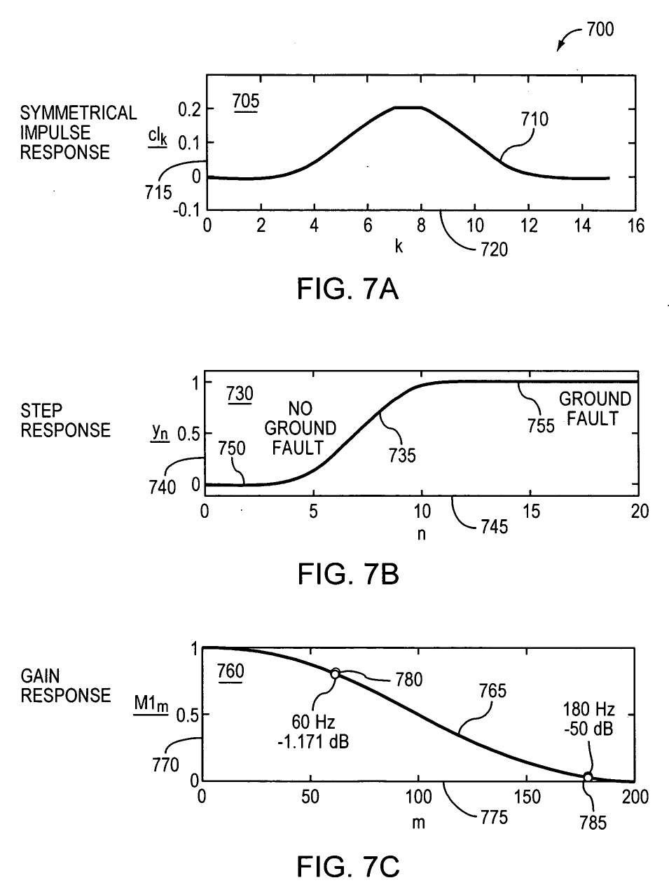

FIGS. 7A-7C represent characteristic response plots 700 of a fast response unit 425 shown in FIG. 4. In one exemplary embodiment of the present invention, the fast response unit may be realized through the use of two finite impulse response (FIR) filters implemented using digital signal processing (DSP) techniques. The fast response unit 425, as shown by way of the plots in FIGS. 7A-7C, is particularly effective at detecting rapidly occurring ground fault currents in the presence of periodic AC noise. For example, the fast response unit may be configured to detect 10 milliamps of ground fault current in approximately 10 milliseconds in the presence of 7.1 milliamps of AC induced current. Larger amounts of ground fault current may be detected in less time.

FIG. 7A is a plot 705 that shows an output response of a first FIR filter with 16-coefficients using a hamming window, a sampling rate of 16 times the power line frequency, and a lowpass cutoff frequency of 100 Hertz. The vertical axis 715 represents the magnitude of the impulse response, and the horizontal axis 720 represents the filter coefficient. As can be seen in the plot 705, the signal trace 710 is symmetrical. Therefore, the value of coefficient 0 is the same as the value of coefficient 15, the value of coefficient 1 is the same as the value of coefficient 14, and so on. Because the value of coefficients 0-7 are equal to the value of coefficients 15-8, respectively, filter data for equivalent coefficients may be calculated in one operation. Thus, the symmetrical nature of the output response effectively reduces the time required to calculate the 16-point FIR filter data in half.

FIG. 7B is a plot 730 that shows a signal 735 representing a step response of the first FIR filter discussed above in reference to FIG. 7A in which a 10 milliamp ground fault current is detected within 10 milliseconds. The vertical axis 740 represents the ground fault detection state, where a ‘zero’ level 750 represents a ‘no ground fault’ condition, and a ‘one’ level 755 represents a ‘ground fault’ condition. The horizontal axis 745 represents the sample number of the sampled signal. The time period for each sample may be determined by calculating the inverse of the sampling frequency. For example, if the sample rate is 960 Hertz (i.e., 16*60 Hertz), the time period for each sample is equal to 1/960 Hertz or 1.042 milliseconds per sample. For the plot 730 shown in FIG. 7B, the step response of the signal 735 indicates a ground fault condition may be detected within approximately 10 samples or approximately 10.4 milliseconds (i.e., 10*1.042 milliseconds).

FIG. 7C is a plot 760 that shows the gain response of a second FIR filter designed to reject periodic AC induced signals according to an exemplary embodiment of the present invention. The vertical axis 770 represents the magnitude of the gain response normalized to 1, and the horizontal axis 775 represents the frequency of the filtered signal 765 in Hertz. A point 780 shown on the signal trace 765 represents the gain response at a power line frequency, for example 60 Hertz. Here, the signal is attenuated approximately −1.71 decibels. The other point 785 shown on the signal trace 765 represents the gain response at 3 times the power line frequency, for example, 180 Hertz. Here, the signal is attenuated by approximately −50 decibels. While the plot 760 shows there is some 60 Hertz rejection, the second FIR filter response provides significant rejection at 180 Hertz. In applications where it is desirable to filter periodic AC signals induced upon a network power line, more energy may be present in the third harmonic, allowing the technique of the present invention to more accurately detect a ground fault condition in the presence of periodic AC induced signals such as the (Telcordia) 7.1 milliamp RMS two-pair specification cited above.

The fast response unit is particularly well adapted to detect rapidly occurring ground fault currents. However, there are occasions where ground fault currents may increase more slowly, increasing over a period of time until the detected current satisfies a ground fault condition criteria. Since the fast response unit is optimized to detect rapidly changing signals (e.g., within 10 milliseconds) and reject periodic AC signals, slowly increasing ground fault currents may not be detected by the fast response unit. The slowly increasing ground fault currents may also be subject to the same periodic AC power induced signals as described above. In this situation, a slow response unit, such as the slow response unit 430 shown in FIG. 4, may be employed to detect slowly increasing ground fault currents in the presence of periodic AC induced current.

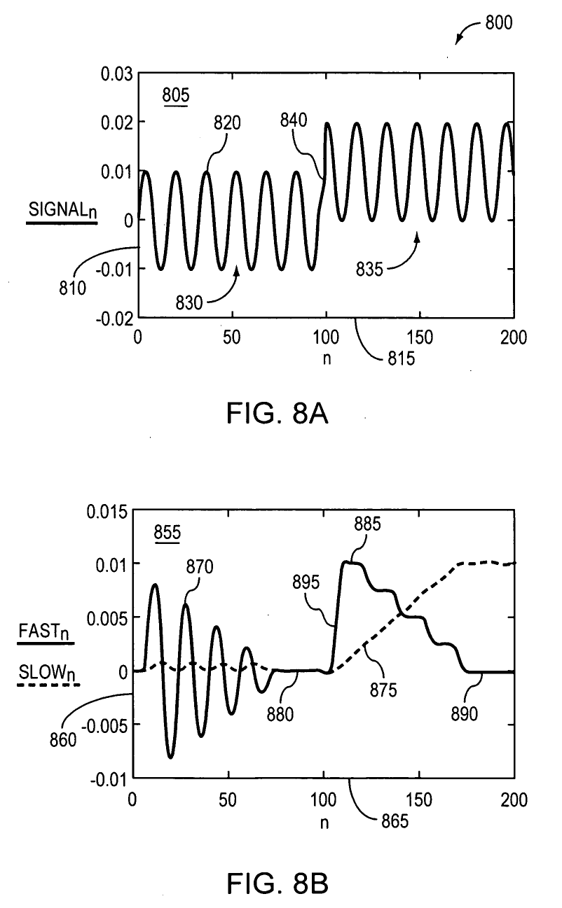

FIG. 8A is a plot 805 produced by a computer simulation that illustrates a ground fault current 820 in the presence of a periodic AC induced signal. The signal 820 may be represented by the equation:

$${x}_{n} = [ \begin{matrix}\sqrt{2} * R * ( sin ( 2 * π * 60 * \frac{n}{Fs} ) + \frac{0}{3} * \\ sin ( 2 * π * 180 * \frac{n}{Fs} ) )\end{matrix} ] + if ( n > 99 , 0.01 , 0 )$$

where R=7.1 milliamps of AC power induced current, n=sample number, and Fs=sampling frequency.

The vertical axis 810 represents the magnitude of the ground fault current in milliamps. The horizontal axis 815 represents the sample number. The plot 805 shows a signal 820 that represents 7.1 milliamp RMS of 60 Hertz induced AC noise with a 10 milliamp ground fault current step. A non-ground fault condition is indicated in the plot region 830 representing samples 0-100. At approximately sample number 100, depicted as a point 840 on the signal trace 820, the detected current experiences a 10 milliamp ground fault current step. The 10 milliamp step continues in the plot region 835 representing approximately samples 101-200. The magnitude of the AC induced current frequently may produce false ground fault detection in prior art systems resulting in unnecessary network power shutdown.

FIG. 8B is a plot 855 produced by computer simulation that illustrates output of the fast response unit 425 and the slow response unit 430 of FIG. 4 in response to an ground fault signal as described above in FIG. 8A (i.e., 10 milliamp ground fault step in presence of a 7.1 milliamp AC induced current) according an exemplary embodiment of the present invention. The vertical axis 860 represents the detected ground fault current in milliamps, and the horizontal axis 865 represents the sample number of the output signals 870, 875. The transition from a non-ground fault condition to a ground fault condition, represented as a 10 milliamp step, occurs at approximately sample number 100 of the signal trace 820.

The solid signal trace 870 represents the output of the fast response unit. In one exemplary embodiment described above, a first FIR filter has 16 coefficients and a step response time of 10 milliseconds and a second FIR filter that subtracts the average of the previous four samples spaced 1/60 Hertz apart. Therefore, fast response unit may detect a quickly increasing ground fault current 895 as shown by the region 885 of the signal trace 870 corresponding to 10 milliamps. However, because of the second FIR filter subtracts the average of the previous 4 samples, both the AC induced signal and the detected ground fault current are rejected after 4 unit intervals of 60 Hertz as shown in the region 880, 890 of the trace 870 corresponding to 0 milliamps. Thus, the fast response unit may detect quickly increasing ground fault currents, but may not detect slowly increasing ground fault currents because of the filtering subtraction.

The dotted signal trace 875 corresponds to the output of the slow response unit. The slow response unit is configured to detect slowly increasing ground fault currents and may be implemented using similar sampling and digital signal processing (DSP) techniques described above. The slow response unit detects the average value over 4 unit intervals of line frequency so that periodic AC induced signals are rejected. For example, if the line frequency is 60 Hertz and is sampled 16 times per unit interval, the average of 64 samples may be determined. The result is that the 7.1 milliamp RMS AC power induced current described above in FIG. 8A is rejected but the desired signal is passed. Therefore, the slow response unit may detect slowly increasing ground fault current in the presence of periodic AC induced current that may be too slow for the fast response unit to detect.

The combination of a fast response unit and a slow response unit enables some embodiments of the present invention to detect fast ground fault currents (e.g., within the 10 millisecond requirement of the Telcordia specification discussed above) and slowly increasing ground fault currents while being immune to false detection from periodic AC power induced currents. As a result, the safety of service personnel is increased and the likelihood of unnecessary network power shutdowns is reduced due to increased immunity to false detection of ground fault events.

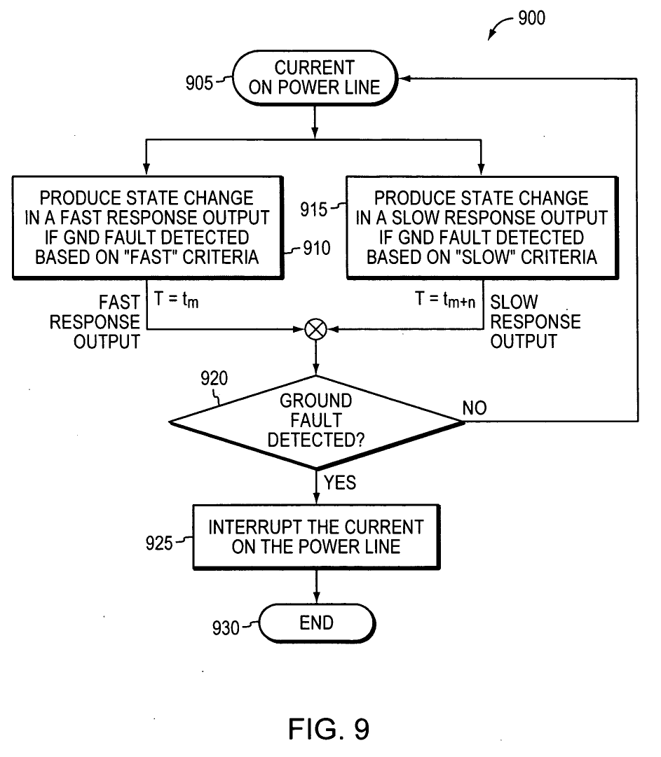

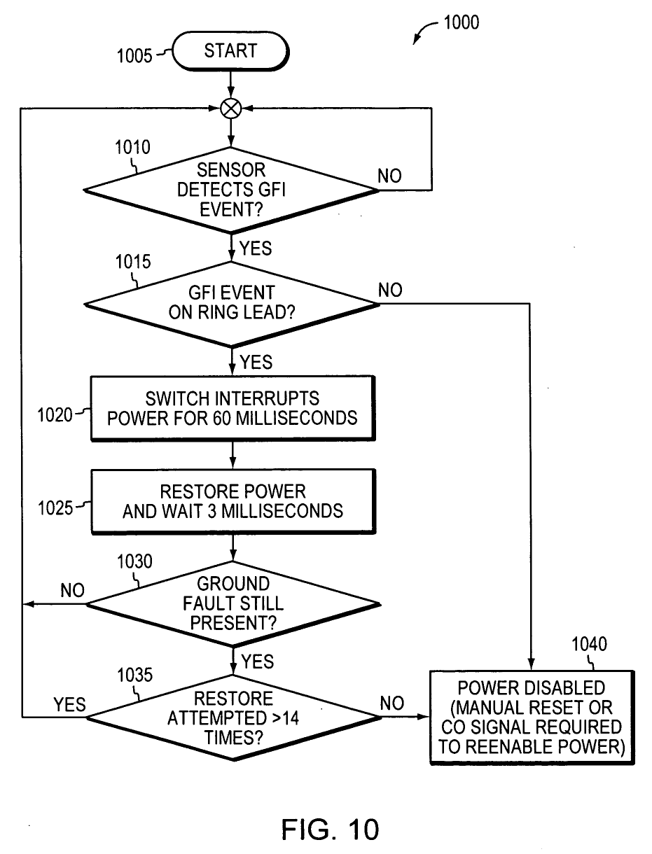

FIG. 9 illustrates, in the form of a flow diagram 900, an exemplary embodiment of a process to interrupt current on a power line in the event a ground fault condition is detected. In a normal operating condition, current is flowing through a telecommunications power line 905. If a ground fault condition is detected based on a “fast” response criteria at time tₘ, a state change in the fast response output is produced 910. Alternatively, or in addition, if a ground fault condition is detected based on a “slow” response criteria at time tₘ₊ₙ, a state change in the slow response output is produced 915. The process then determines if a ground fault condition has been detected. If a ground fault condition is no longer detected, current is allowed to flow on the power line 905. However, if the ground fault condition is still detected 920, current on the power line is interrupted, 925. A continuous ground fault condition may result in the power being interrupted, and the detection process ends 930. Manual intervention may be required to restore power, for example, by a service person performing a manual reset or through an initiation of a reset signal sent from a central office.

FIG. 10 is a flow diagram of an example process 1000 employed by the ground fault interrupter 305 as shown in FIG. 3 of the present invention. The process 1000 starts 1005 by determining is a ground fault condition has occurred 1010. If the sensor detects a ground fault interrupt event 1010, the process 1000 may determine if the ground fault event is on a tip lead. If the ground fault event occurs on the tip lead 475, the process 1000 may disable power by opening the ring lead via a solid state or mechanical switch, and power is disabled. Power remains disabled, and manual intervention may be required to restore power, for example, by a service person performing a manual reset or through the initiation of a reset signal sent from the central office. If the ground fault event occurs on a ring lead, the process may interrupt power for a predetermined period of time 1020 (e.g., 60 milliseconds) by opening a switch on the power line. After the interruption time period has expired, power may be restored 1025, and the process 1000 waits a predetermined period of time (e.g., 3 milliseconds) to allow the power to stabilize.

The process 1000 then determines if the ground fault condition is still present 1030. If the ground fault condition is no longer present, the process 1000 continues to monitor the power lines for ground fault interrupt events 1010. If the ground fault condition is still present, the process checks to determine if power has been restored a predetermined number of times 1035 (e.g., 14). If power has been restored more that the predetermined number of time, power is disabled 1040 and may be restored, for example, through use of a manual reset or a manual reset signal transmitted from a central office. If power has been restored less than the predetermined number of times, the process 1000 continues to monitor the power lines for ground fault interrupt events 1010.

It should be understood that the process 1000 described in FIG. 10 is an example embodiment used for illustration purposes only. Other embodiments within the context of interrupting current on a power line may be employed.

Some or all of the steps in the process 1000 may be implemented in hardware, firmware, or software. If implemented in software, the software may be (i) stored locally with the ground fault interrupter 305 or (ii) stored remotely and downloaded to the ground fault interrupter 305 during, for example, start 1005. The software may also be updated locally or remotely. To begin operations in a software implementation, the ground fault interrupter 305 loads and executes the software in any manner known in the art.

It should be apparent to those of ordinary skill in the art that methods involved in the present invention may be embodied in a computer program product that includes a computer usable medium. For example, such a computer usable medium may consist of a read-only memory device, such as a CD-ROM disk or convention ROM devices, or a random access memory, such as a hard drive device or a computer diskette, having a computer readable program code stored thereon.

While this invention has been particularly shown and described with references to example embodiments thereof, it will be understood by those skilled in the art that various changes in form and details may be made therein without departing from the scope of the invention encompassed by the appended claims.

What is claimed is:

1. An apparatus for interrupting a ground fault, comprising:
a fast response unit configured to produce a state change of a fast response output, based on a current on a power line, to indicate a ground fault at a first time after the ground fault occurs;
a slow response unit configured to produce a state change of a slow response output, based on the current on the power line, to indicate a ground fault at a second time after the ground fault occurs, the second time being later than the first time; and
a switch configured to be responsive to the state change of the fast and slow response outputs to interrupt the current on the power line in an event the state change in the fast or slow response output indicates a ground fault.

2. The apparatus according to claim 1 wherein the state change in the fast and slow response units include filters with respective transfer functions.

3. The apparatus according to claim 1 wherein the state change in the fast response unit is configured to indicate a ground fault due to a fast increase in a DC bias level of the current and the slow response unit is configured to indicate a ground fault due to a slow increase in the DC bias level of current.

4. The apparatus according to claim 1 wherein the state change in the fast response unit is configured to indicate a ground fault in an event the current exceeds a threshold for a given length of time.

5. The apparatus according to claim 4 wherein the power line includes tip and ring leads and wherein the fast response unit is configured to produce the state change in the fast response output to indicate a ground fault in an event the fast response unit detects approximately 10 ma or greater of current on the ring lead for at least 10 ms.

6. The apparatus according to claim 5 further including a reset unit coupled to the fast response unit and configured to reset the switch to allow multiple interruptions of the current on the power line.

7. The apparatus according to claim 1 wherein the power line includes at least one pair of wires sensitive to AC induction and wherein the filters produce respective outputs unaffected by the AC induction current up to a threshold.

8. The apparatus according to claim 7 wherein the threshold is at least approximately 3.55 ma per pair of wires or at least approximately 7.1 ma per two pairs of wires.

9. The apparatus according to claim 1 further including a reporting unit that reports a ground fault condition by way of a local visible or audible signal observable by an operator.

10. The apparatus according to claim 1 further including a sensor configured to provide a signal substantially free of common mode noise representative of the current on the power line to the slow response unit and the fast response unit.

11. The apparatus according to claim 1 wherein the fast response unit is configured to produce a step response that reaches approximately a maximum value in about 10 ms corresponding to a ground fault of about 10 ma.

12. The apparatus according to claim 1 wherein the fast response unit has a symmetrical impulse response.

13. The apparatus according to claim 1 wherein the fast response unit is configured to attenuate a third harmonic of a fundamental frequency of a power line frequency.

14. The apparatus according to claim 1 wherein the fast response unit is a digital finite impulse response filter.

15. The apparatus according to claim 1 wherein the fast response unit includes a sampler and a digital filter, the sampler configured to sample the current or representation thereof at a rate synchronous with a power line frequency.

16. The apparatus according to claim 1 wherein the slow response unit is configured to average measurement data of the current over a specific number of periods of a frequency of the current on the power line.

17. The apparatus according to claim 16 wherein the slow response unit has a transfer function to average measurement data over multiple periods of the frequency of the current to reject the frequency from causing a false indication of a ground fault.

18. The apparatus according to claim 16 wherein the slow response unit is configured to remove a DC offset in the measurement data.

19. The apparatus according to claim 1 wherein the slow response unit is configured to attenuate a fundamental power line frequency.

20. An method for interrupting a ground fault, comprising:
producing a state change of a fast response output, based on a current on a power line, to indicate a ground fault at a first time after the ground fault occurs;
producing a state change of a slow response output, based on the current on the power line, to indicate a ground fault at a second time after the ground fault occurs, the second time being later than the first time; and
interrupting the current on the power line in an event the state change of the fast or slow response output indicates a ground fault.

21. The method according to claim 20 wherein producing the state change in the fast and slow response outputs includes filtering a representation of the current with respective transfer functions to produce state change in the fast and slow response outputs.

22. The method according to claim 20 wherein producing the state change in the fast response output is due to a fast increase in a DC bias level of the current and producing the state change in the slow response output is due to a slow increase in the DC bias level of current.

23. The method according to claim 20 wherein producing the state change in the fast response output includes producing the state change in an event the current exceeds a threshold for a given length of time.

24. The method according to claim 23 wherein the power line includes tip and ring leads and producing the state change in the fast response output to indicate a ground fault in an event approximately 10 ma or greater of current is present on the ring lead for at least 10 ms.

25. The method according to claim 24 further including restoring current on the power line to allow multiple interrupting of the current on the power line, multiple times during presence of the ground fault.

26. The method according to claim 20 wherein the power line includes at least one pair of wires sensitive to AC induction and wherein producing a state change in the fast and slow response outputs is unaffected by the AC induction current up to a threshold.

27. The method according to claim 26 wherein the threshold is at least approximately 3.55 ma per pair of wires or at least approximately 7.1 ma per two pairs of wires.

28. The method according to claim 20 further including reporting a ground fault condition by way of a local visual or audible signal observable by an operator.

29. The method according to claim 20 further including providing a signal substantially free of common mode noise representative of the current on the power line.

30. The method according to claim 20 wherein producing the state change in the fast response output includes producing a step response that reaches approximately a maximum value in about 10 ms corresponding to a ground fault of about 10 ma.

31. The method according to claim 20 wherein the state change in the fast response output has a symmetrical impulse response.

32. The method according to claim 20 wherein producing the state change in the fast response output includes attenuating a third harmonic of a fundamental frequency of a power line frequency.

33. The method according to claim 20 wherein producing the state change in the fast response output includes using a digital finite impulse response filter to produce the output.

34. The method according to claim 20 wherein producing the state change in the fast response output includes sampling and digital filtering the current or representation thereof, the sampling at a rate synchronous with a power line frequency.

35. The method according to claim 20 wherein producing the state change in the slow response output includes averaging measurement data of the current over a specific number of periods of a frequency of the current on the power line.

36. The method according to claim 35 wherein producing the state change in the slow response output includes averaging measurement data over multiple periods of the frequency of the current to reject the frequency from causing a false indication of a ground fault

37. The method according to claim 35 wherein producing the state change in the slow response output includes removing a DC offset in the measurement data.

38. The method according to claim 20 wherein producing the state change in the slow response output includes attenuating a fundamental power line frequency.

39. An apparatus for interrupting a ground fault, comprising:
means for producing a state change of a fast response signal, based on a current on a power line, to indicate a ground fault at a first time after the ground fault occurs;
means for producing a state change in a slow response signal, based on the current on the power line, to indicate a ground fault at a second time after the ground fault occurs, the second time being later than the first time; and
means responsive to the state change in the fast and slow response signals for interrupting the current on the power line in an event the fast or slow response signal indicates a ground fault.
